(19) United States
(12) Patent Application Publication
(10) Pub. No.: US 2023/0201704 A1
(43) Pub. Date: Jun. 29, 2023

(54) CARD GAME TABLE AND GAME METHOD USING SAME

(71) Applicant: Moonkwon CHOI, Yongin-si (KR)

(72) Inventor: Moonkwon CHOI, Yongin-si (KR)

(21) Appl. No.: 17/833,189

(22) Filed: Jun. 6, 2022

(30) Foreign Application Priority Data
Dec. 28, 2021 (KR) 10-2021-0189832

(51) Int. Cl. A63F 3/00

(52) U.S. Cl. CPC A63F 3/00157; A63F 2003/00164

(57) ABSTRACT

Provided are a card game table, on which betting is made in a win-loss method using numbers or patterns of cards and award rates for respective rounds are differentially applied to progress a game, and a game method using the same. The card game table includes a leg that is integrally fixed to a bottom surface of a game table and supports the game table at a certain height, a game pad that is provided on an upper surface of the game table at which a dealer and players are located and has a layout including a betting zone and a card placement zone necessary for progress of a card game, and a text indicating betting award rate information for each round on the upper surface of the game table adjacent to the betting zone.

### CROSS-REFERENCE TO RELATED APPLICATION

This application claims priority to and the benefit of Korean Patent Application No. 10-2021-0189832 filed on Dec. 28, 2021, the disclosure of which is incorporated herein by reference in its entirety.

### BACKGROUND

### 1. Field of the Invention

The present disclosure relates to a game table that is installed in a casino or the like and is used when a card game or the like is played, and more particularly, to a card game table on which a bet is made in a win-loss method using numbers or patterns of cards and award rates for respective rounds are differentially applied to progress a game, and a game method using the same.

### 2. Discussion of Related Art

Currently, legal casino sites recognized by countries are being operated at home and abroad, and various games such as table games such as baccarat and blackjack, roulette, and big wheel are being operated in the casino sites.

In general, a baccarat game is a simple game in which a player guess whether a banker or the player wins at cards presented by a dealer, and many people may participate in and enjoy the baccarat game without knowing the difficult rules of the game. A player may enjoy the baccarat game by entering the casino sites and directly participating in the baccarat game or may indirectly enjoy the baccarat game by developing a baccarat game system as in Korean Patent Application Publication No. 10-2005-0056110 (published date: Jun. 14, 2005) and Korean Patent Application Publication No. 10-2012-0021502 (published date: Mar. 9, 2012).

Meanwhile, a method of directly participating in the baccarat game progresses in a state in which the dealer and game players sit around a game table. Boxes with numbers 1 to 7 are present on one side of the game table, boxes with numbers 8 to 15 are present on the other side thereof, and thus totally 15 boxes with numbers are present. In a state in which the game players sit in front of the respective boxes, the game players selectively bet on the banker, the player, or a tie using cards distributed by the dealer.

In this way, in the case of the table games, dealers progress the games on the corresponding table. Further, in the table games, the dealer deals cards according to determined rules, and a win or loss is determined according to the game rules. In this case, the player may select a betting target before the cards are dealt and bet using game chips, and may make additional bets according to a result of the dealt cards depending on the game.

Finally, the dealer uses the betted chips to award dividends according to an award rate to the players according to the outcome of the game, and thus one game is completed.

However, in the case of the conventional card game, even in the baccarat game that is a simple game, set rules for a game method vary, the boxes marked on the game table to bet the game chips are complex, and thus a player who plays the game for the first time may take some time to participate in the game.

Further, in the case of the conventional card game, one game is completed with one win/loss decision in which the player selects the betting target to bet the game chips and the dealer deals the cards. Thus, there is an inconvenience that the dealer should repeat a process of shuffling and dealing cards every time a following round of the game progresses, and the player should wait for the dealer to deal cards every time the game continues.

That is, the player who wants to bet a lot of game chips in a short period of time may feel frustration, and the dealer shuffles and deals cards in every game, resulting in physical exertion.

### SUMMARY OF THE INVENTION

The present disclosure is directed to providing a card game table, on which a bet is made in a win-loss method using numbers or patterns of cards and award rates for respective rounds are differentially applied to progress a game, and a game method using the same.

The present disclosure is also directed to providing a card game table, on which a player who plays a game for the first time may participate in the game using simple game rules, and a game method using the same.

The present disclosure is also directed to providing a card game table, on which a player selects a betting target to bet game chips, and at least two rounds progress in one deal of the cards by the dealer, and thus the game may progress two or more times, and a game method using the same.

The present disclosure is also directed to providing a card game table, on which a dividend following a higher award rate for a betting target is awarded to a player according to a winning rate of consecutive rounds, and a game method using the same.

The purposes of the present disclosure may be not limited to the purposes described above, and other purposes and advantages of the present disclosure that are not described may be understood by the following description and may be more clearly understood by embodiments of the present disclosure. Further, it may be easily identified that the purposes and advantages of the present disclosure may be implemented by units and combinations thereof described in the appended claims.

A card game table on which a dealer location zone is formed and a plurality of game player location zones facing the dealer location zone are formed includes a leg that is integrally fixed to a bottom surface of a game table and supports the game table at a certain height, a game pad that is provided on an upper surface of the game table on which a dealer and players are located and has a layout including a betting zone and a card placement zone necessary for progress of a card game, and a text indicating betting award rate information for each round on the upper surface of the game table adjacent to the betting zone, wherein the betting zone is a region in which a player places game chips for betting when the card game progresses and which is formed adjacent to game player location zones (B), is provided with a pair of sides (a red side and a blue side), is configured as a layout having a plurality of regions to which a first round to an Nth round (N is an integer greater than 1) are sequentially designated, and is additionally configured with a layout having an option region at an uppermost end (an upper end of the Nth round), the card placement zone is a region in which the dealer places cards for progress of the card game when the card game progresses and which is formed adjacent to a dealer location zone (A), is provided with a pair of sides (a red side and a blue side), and is configured as a layout having a plurality of regions to which a first round to an Nth round (N is an integer greater than 1) are sequentially designated, and in the card placement zone, after betting for each round, eight cards are dealt to the red side and the blue side at once, different cards are located on the sides one by one, cards located on the red side and the blue side for each round are turned over, and outcome between the red side and the blue side is determined through a predetermined rank by comparing numbers or symbols (patterns) marked on the cards.

In the betting zone, based on the same amount of game chips for each round, as the round becomes higher, an award rate for a betting amount may be set to become higher, and a betting award rate for an option betting may be highest.

A table card game method performed in a casino, in which a dealer and a player participate, includes (A) positioning game chips on any one of a pair of a red side and a blue side configured on a betting zone in a layout having a plurality of regions to which a first round to an Nth (an integer greater than 1) round are sequentially designated, (B) positioning different cards one by one on the pair of the red side and the blue side formed in a card placement zone such that rear surfaces of the cards are visible in the layout having the plurality of regions to which the first round to the Nth round are sequentially designated, (C) comparing numbers or symbols marked on the cards located on the red side and the blue side located on the first round of the card placement zone and determining an outcome between the red side and the blue side through a predetermined rank, (D) determining the outcome of the first round between the red side and the blue side of the betting zone according to a determined result of (C), awarding game chips located on a side determined as a winner of the first round in accordance with a betting award rate of the first round, and forfeiting all game chips located on the side determined as a loss of rounds including the round and all rounds subsequent thereto, (E) determining the outcome by sequentially comparing the cards located in the card placement zone on the red side and the blue side for each round based on presence or absence of the game chip located in the betting zone, and (F) determining the outcome for each round between the red side and the blue side in the betting zone according to a determined result of (E) and awarding or forfeiting the game chips for each round in the same manner as in (D).

The table card game method may further include positioning the game chip on an uppermost end of any one of the pair of the red side and the blue side in a layout having regions divided from the first round to the n^{th} (an integer greater than 1) round as an option game separately from a round-by-round game in the (B).

A bet on the option game may be determined as a win when patterns or numbers of the cards in all the rounds in any one of the red side and the blue side are the same.

As the round becomes higher, the betting award rate becomes higher.

The table card game method may include progressing a game to a next round without award or forfeit when the outcome between the red side and the blue side is a tie as a determined result.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating a structure of a card game table according to an embodiment of the present disclosure;

FIG. 2 is a plan view illustrating a structure of a card game table according to an embodiment of the present disclosure; and

FIGS. 3A to 3E are views for describing a game method using the card game table according to an embodiment of the present disclosure.

### DETAILED DESCRIPTION OF EXEMPLARY EMBODIMENTS

Other purposes, characteristics, and advantages of the present disclosure will become apparent from the detailed description of embodiments with reference to the accompanying drawings.

Terms used herein have been selected as currently widely used general terms as possible while considering functions in the present disclosure but may be changed according to the intention or precedent of an engineer in the field, the emergence of a new technology, and the like. Further, in a specific case, a term is arbitrarily selected by the applicant, and in this case, the meaning thereof will be described in detail in the corresponding description of the disclosure. Thus, the terms used herein should be defined on the basis of meaning of the terms and the entire contents of the present disclosure not simple names of the terms.

Exemplary embodiments of a card game table and a game method using the same according to the present disclosure will be described below with reference to the accompanying drawings. However, the present disclosure is not limited to the embodiments disclosed below but may be implemented in various different forms, and the present embodiment is merely intended to complete the present disclosure and is provided to completely inform those skilled in the art of the scope of the present disclosure. Thus, since the embodiments described in the present specification and configurations illustrated in the drawings are merely the most exemplary embodiments of the present disclosure and do not represent all the technical spirit of the present disclosure, it should be understood that various equivalents and variations that may replace the embodiments and the configurations may be present at a time in which the present application is filed.

Hereinafter, a state in which a predetermined component is disposed on an “upper side (or a lower side)” of a component or “above (or below)” the component may mean that another component may be interposed between the component and the predetermined component disposed above (or below) the component as well as that the predetermined component is disposed in contact with an upper surface (or a lower surface) of the component.

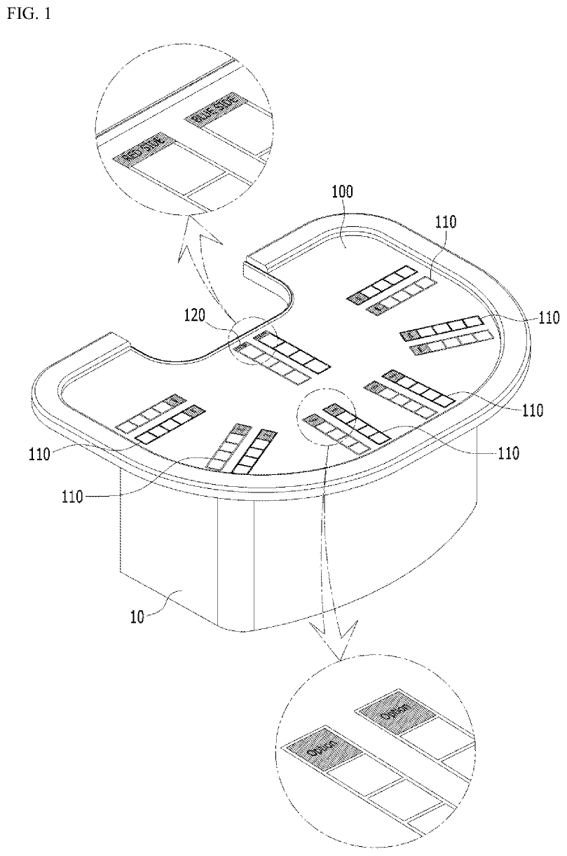

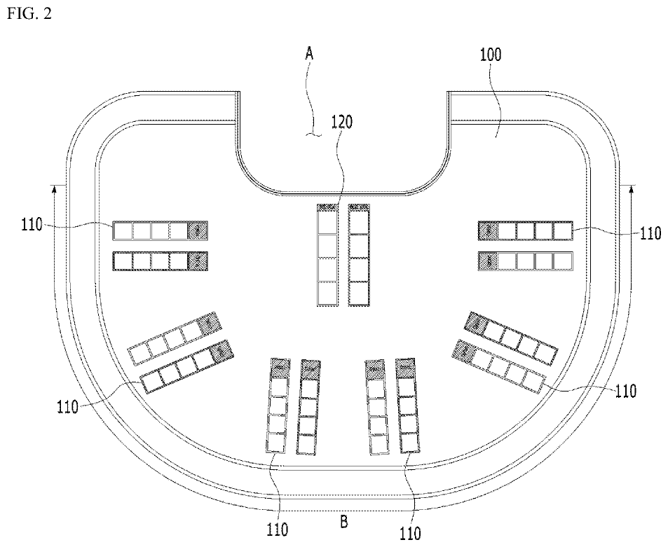

FIG. 1 is a perspective view illustrating a structure of a card game table according to an embodiment of the present disclosure, and FIG. 2 is a plan view illustrating a structure of a card game table according to an embodiment of the present disclosure.

As illustrated in FIGS. 1 and 2, the card game table according to the present disclosure includes a game table 100 having legs 10, in which a dealer location zone A is formed at one side thereof and a plurality of game player location zones B are formed at the other side thereof facing the dealer location zone A. The game table 100 may include the one dealer location zone A and the plurality of game player location zones B.

A game pad in which a layout including a betting zone 110 and a card placement zone 120 required for progress of a card game is implemented may be provided on the game table 100 at which a dealer and players are located. In this case, the betting zone 110 is a zone in which the player places game chips for betting when the card game progresses, and the card placement zone 120 is a zone in which the dealer places cards for the progress of the game when the card game progresses. Thus, the size of the card placement zone 120 in which the cards are located may be formed in a wider layout than the betting zone 110 in which the game chips are located.

The card placement zone 120 may be formed adjacent to the dealer location zone A so that the dealer may easily place the cards therein, and the betting zone 110 may be formed adjacent to the game player location zones B so that the game chips may be easily placed therein when the players make bets.

The betting zone 110 may be located in each of the plurality of game player location zones B. Further, the betting zone 110 may be provided with a pair of sides (a red side and a blue side) having different colors and may be configured as a layout having a plurality of regions to which a first round to an Nth round (N is an integer greater than 1) are sequentially designated.

The betting zone 110 may be additionally configured with a layout having an option region at the uppermost end (an upper end of the N^{th} round). The option region is a region in which the player may additionally bet game chips on an option game in which additional betting is possible, which is separate from a round-by-round game including the first round to the N^{th} round when the card game progresses. In the present specification, for easy description, as an embodiment, description will be limited to a game including the first round to a fourth round. However, the number of rounds is not limited thereto and may be less or more than four.

In the betting zone 110, a betting award rate for each round may be differentially applied. In the betting zone 110, on the basis of the same amount of the game chips for each round, the award rate for the betting amount may become higher as the round becomes higher. As an example, in the first round, the betting award rate is one times the betting amount, in the second round, the betting award rate is two times the betting amount, in the third round, the betting award rate is five times the betting amount, and in the fourth round, the betting award rate is 10 times the betting amount.

Meanwhile, in option betting, the betting award rate is 50 times the betting amount, which is separate from the betting award rate for each round. The betting award rate is merely an exemplary embodiment, and the present disclosure is not limited thereto. However, as the round becomes higher, the betting award rate may become higher, and the betting award rate for the option betting may be highest.

The round-by-round bets in the betting zone 110 may be made from at least the second round to the fourth round on the basis of the same amount for each round only during an initial betting time. Further, in the option betting in the betting zone 110, the bets may be made on the option game only during the initial betting time. As an embodiment, the option betting may be awarded to a player who makes the option bet on the corresponding side when all four cards of the red side (the first round to the fourth round) and the blue side (the first round to the fourth round) have the same pattern or card number.

In the round-by-round betting and the option betting, additional betting is not possible after the game starts, and the bets may be made on only one of the red side and the blue side. That is, the player cannot make bets on the red side and the blue side at the same time.

Meanwhile, the card placement zone 120 may be located in the dealer location zone A. The card placement zone 120 may be provided with a pair of sides (a red side and a blue side) having different colors and may be configured as a layout having a plurality of regions to which a first round to an Nth round (N is an integer greater than 1) are sequentially designated.

In the card placement zone 120, eight cards are dealt to the red side and the blue side at once, and a pair of different cards are positioned on each side. After the round-by-round betting, the cards located on the red side and the blue side are turned over for each round, the numbers or symbols (patterns) marked on the cards are compared, and thus the outcome between the red side and the blue side may be determined through a predetermined rank. As an example, in the case of a number, as a result of the comparison, a side having a higher number may be determined as a winner, and a side having a lower number may be determined as a loser. Further, in the case of a trump shape, in the order of [symbol] >♦>♥> [symbol] , a side having a higher order pattern may be determined as a winner, and a side having a lower order pattern may be determined as a loser. In this case, the used card may be a trump card having a number and a symbol marked on one surface thereof, but the present disclosure is not limited thereto, and any card having at least one of a number, a symbol, and a picture marked thereon by which outcome may be determined through comparison may be used.

As a result of comparing the cards located on the red side and the blue side for each round of the card placement zone 120, the winning player is awarded game chips corresponding to the betting award rate of the corresponding round on the basis of the betting amount bet in the corresponding round, and the losing player forfeits all game chips (all game chips bet on the betting zone 110) bet in all rounds including the lost round.

In the card placement zone 120, after eight cards are dealt to the red side and the blue side at once, betting customers may squeeze the card game or the dealer may progress the card game for each round, and the awarding may progress for each round when the game is finished. That is, the card game may progress for each hand.

Meanwhile, the betting zone 110 and the card placement zone 120 are arranged toward the player. That is, when viewed by the player located at the game table 100, the betting zone 110 and the card placement zone 120 are arranged in a direction in which an option betting zone is located at an upper end thereof and the first round is located at a lower end thereof. Thus, the player may very intuitively determine a side indicating the outcome of the cards located in the card placement zone 120 and a side of the betting zone 110 on which the player himself/herself makes bets because the left and right locations of the red side and the blue side of the card placement zone 120, in which the cards are located, are the same as the left and right locations of the red side and the blue side of the betting zone 110, in which the game chips are located.

Further, at least one text indicating betting award rate information for each round may be marked on an upper surface of the game table 100 adjacent to the betting zone 110.

A game method using the card game table according to the present disclosure as configured above will be descried below in detail with reference to the accompanying drawings. The same reference numerals as in FIG. 1 or 2 refer the same members performing the same functions.

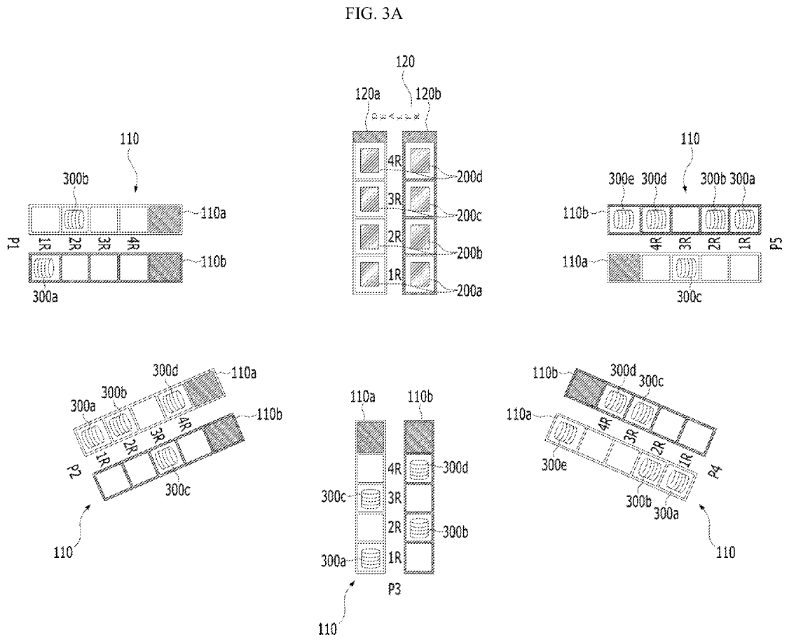

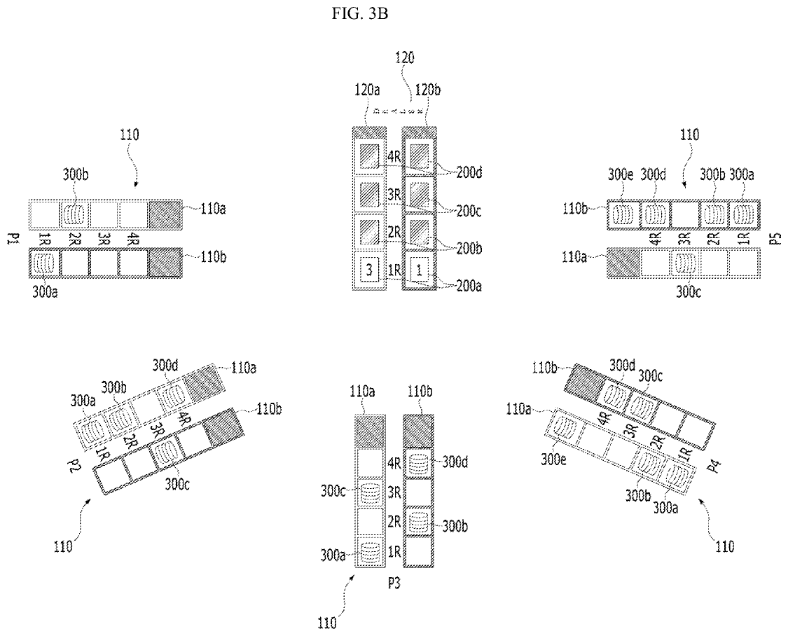

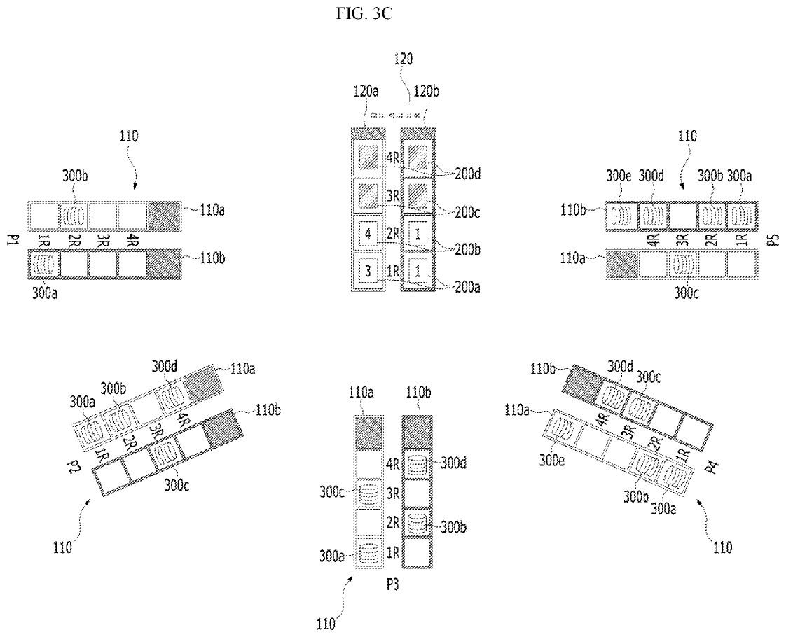

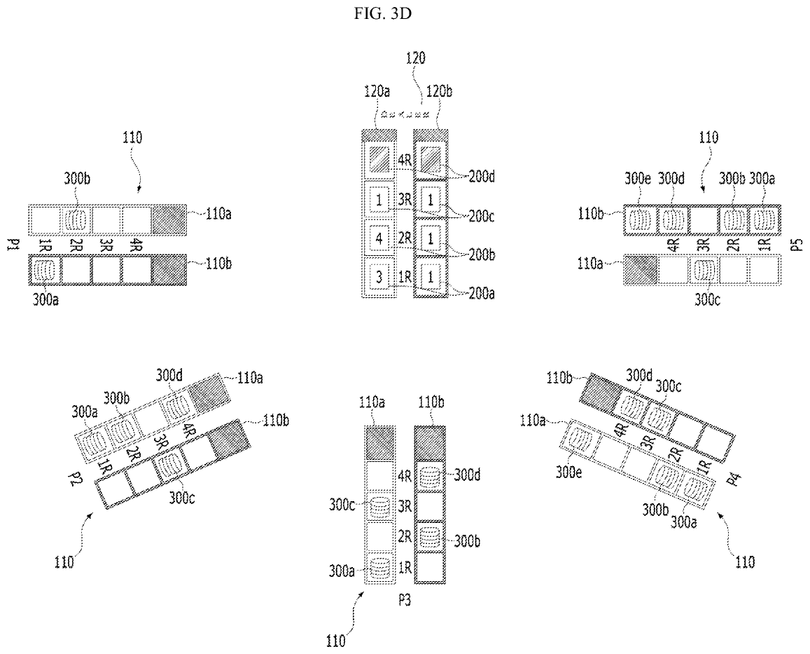

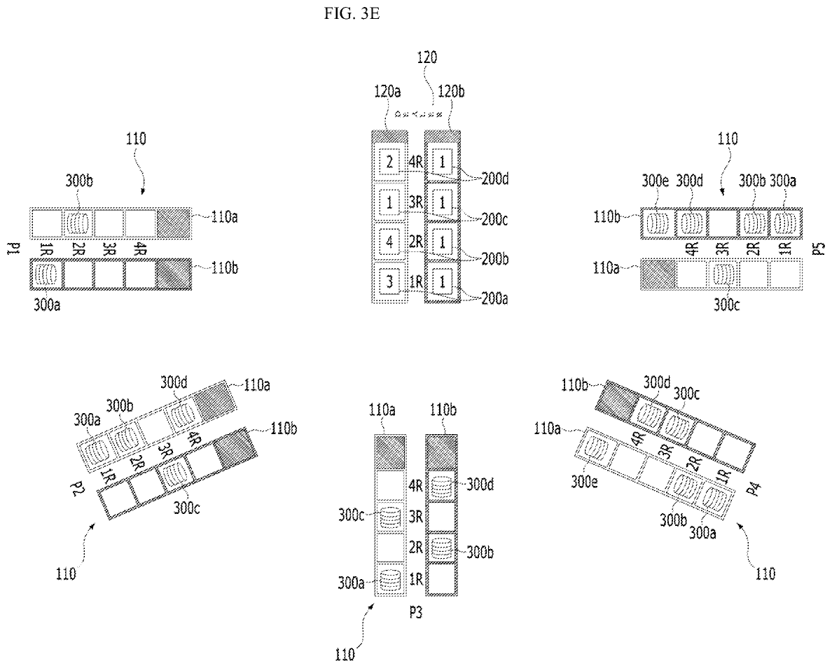

FIGS. 3A to 3E are views for describing a game method using the card game table according to an embodiment of the present disclosure.

Referring to FIGS. 3A to 3E, first, as illustrated in FIG. 3A, the players bet game chips corresponding to a certain amount on any one of the red side and the blue side for each round in their betting zones 110. In this case, the betting amount should be the same for each round, and the players may make bets on at least from the second round to the fourth round. Separately from the betting for each round, the players may make bets in the option betting zone located at the uppermost end (an upper end of the fourth round). The option betting is betting on the option game in which the players may additionally make bets separately from the games played from the first round to the fourth round, and when all the patterns or numbers of the four cards are the same on the betting side among the red side (the first round to the fourth round) and the blue side (the first round to the fourth round), game chips are awarded according to the award rate for the option betting.

Next, when the betting of the players is completed, the dealer deals eight cards at once such that different cards are located one by one on the red side and the blue side of the card placement zone 120. That is, the dealer places cards on a red side 120a and a blue side 120b located on the first round to fourth round 200a to 200d of the card placement zone 120 such that the rear surfaces of the cards are visible.

As an example, five players P1 to P5 make bets using game chips, and the first player P1 makes a bet on the blue side 110b in a first round 300a and makes a bet on the red side 110a in a second round 300b. That is, the first player P1 makes bets only on the first round and the second round that are minimum betting rounds. Further, the second player P2 makes a bet on the red side 110a in the first round 300a, the second round 300b, and a fourth round 300d and makes a bet on the blue side 110b in a third round 300c. That is, the second player P2 makes bets on the first round to the fourth round. Further, the third player P3 makes a bet on the red side 100a in the first round 300a and the third round 300c and makes a bet on the blue side 110b in the second round 300b and the fourth round 300d. That is, the third player P3 makes bets on the first round to the fourth round. Further, the fourth player P4 makes bets on the red side 100a in the first round 300a and the second round 300b, makes bets on the blue side 110b in the third round 300c and the fourth round 300d, and additionally makes an option bet on the red side 110a. That is, the fourth player P4 makes bets on the first round to the fourth round and additionally makes the option bet on the red side 110a. Further, the fifth player P5 makes a bet on the red side 110a in the third round 300c, makes bets on the blue side 110b in the first round 300a, the second round 300b, and the fourth round 330d, and additionally makes an option bet on the blue side 110b. That is, the fifth player P5 makes bets on the first round to the fourth round and additionally makes the option bet on the blue side 110b.

Next, as illustrated in FIG. 3B, when the betting for each round is completed by the players P1 to P5, the dealer deals four cards to the red side and four cards to the blue side in the card placement zone 120 and then turns over the cards located on the red side 120a and the blue side 120b located in the first round 200a so that the number or symbols of the cards are exposed to the outside. The dealer may determine the outcome between the red side 120a and the blue side 120b through a predetermined rank by comparing the numbers or symbols marked on the cards located in the first round 200a.

In the case of FIG. 3B, the number of a card located in the first round 200a on the red side 120a of the card placement zone 120 is 3, the number of a card located in the first round 200a on the blue side 120b is 1, and thus the red side 120a wins, and the blue side 120b loses.

As a result of the comparison between the cards of the first round 200a, as the red side 110a wins, the second, third, and fourth players P2, P3, and P4 who make bets on the red side 110a in the first round 300a of the betting zone 110 become winners, and the first and fifth players P1 and P5 who make bets on the blue side 110b in the first round 300a of the betting zone 110 become losers.

Thus, the dealer awards game chips to the winning second, third, and fourth players P2, P3, and P4 in accordance with the betting award rate of the first round on the basis of the betting amount and forfeits all game chips (all game chips bet in the betting zones 110a and 110b) of all rounds on which the lost first and fifth players P1 and P5 make bets.

In this way, game chips located in all subsequent rounds including the lost round are forfeited from the losing player. Further, the winning player may be awarded game chips in accordance with the betting award rate for the corresponding round. Further, the winning player may progress to a next round of the game. In this case, continuous progress of the next round of the game may be performed only when the betting progressed after game chips for the next round were placed during the initial betting time.

The betting award rate becomes higher and higher as the rounds progress. That is, in the first round, the betting award rate is one times the betting amount, in the second round, the betting award rate is two times the betting amount, in the third round, the betting award rate is five times the betting amount, and in the fourth round, the betting award rate is 10 times the betting amount. Further, in the option betting, the betting award rate is 50 times the betting amount.

In this way, as the betting award rate increases whenever the next round progresses, the players are motivated to play the game in the next round. However, when the players lose the corresponding round, game chips bet on all rounds are forfeited, and thus the players need to have good judgement. For reference, game chips awarded for winning the first round may not be forfeited even when the players lose the second round, and only game chips bet on a round higher than the corresponding round may be forfeited.

Accordingly, as the first player P1 and the fifth player P5 lose in the first round, game chips bet on all the rounds are forfeited, and as the second, third, and fourth players P2, P3, and P4 win in the first round, game chips bet by one times the betting award rate of the first round will be awarded.

However, as the fourth player P4 and the fifth player P5 make the option bet on the blue side 110b in addition to the round betting, the game is not completed until cards of all the rounds are turned over and viewed. As an example, in the option betting, a winner is determined when the numbers or symbols of cards of all the rounds located on the option betting side (one of the red side 110a and the blue side 110b) are the same.

Thus, the second, third, and fourth players P2, P3, and P4 and the fifth player P5 who are winners progress to the next round of the game, and the game is over for the first player P1 who is a loser.

Next, the dealer turns over the cards located on the red side 120a and the blue side 120b located in the second round 200b of the card placement zone 120 so that the numbers or symbols are exposed to the outside. The dealer may determine the outcome between the red side 120a and the blue side 120b through a predetermined rank by comparing the numbers or symbols marked on the cards located in the second round 200b.

In the case of FIG. 3C, the number of a card located in the second round 200b on the red side 120a of the card placement zone 120 is 4, the number of a card located in the second round 200b on the blue side 120b is 1, and thus the red side 120a wins, and the blue side 120b loses.

As a result of the comparison between the cards of the second round 200b, as the red side 110a wins, the second and fourth players P2 and P4 who make bets on the red side 110a in the second round 300b of the betting zone 110 become winners, and the third player P3 who makes bets on the blue side 110b in the second round 300b of the betting zone 110 becomes a loser.

Thus, the dealer awards game chips to the winning second and fourth players P2 and P4 in accordance with the betting award rate of the second round on the basis of the betting amount and forfeits all game chips (all game chips bet in the betting zones 110a and 110b) of second, third, and fourth rounds on which the losing third player P3 makes bets. That is, as the second and fourth players P2 and P4 win in the second round, game chips bet by two times the betting award rate of the second round will be awarded.

Meanwhile, since all the numbers of open cards on the blue side 110b of the card placement zone 120 are equally 1, the fifth player P5 who makes the option bet on the blue side 110b has not yet finished the game until the cards of all the rounds are turned over and viewed. Further, since the numbers of cards open on the red side 110a of the card placement zone 120 are 3 and 4 which are different from each other, the fourth player P4 who makes the option bet on the red side 110a becomes a loser, and game chips which the fourth player P4 bets on the option betting are forfeited.

Thus, the second and fourth players P2 and P4 and the fifth player P5 who are winners progress to the next round of the game, and the game is over for the third player P3 who is a loser.

Next, the dealer turns over the cards located on the red side 120a and the blue side 120b located in the third round 200c of the card placement zone 120 so that the numbers or symbols are exposed to the outside. The dealer may determine the outcome between the red side 120a and the blue side 120b through a predetermined rank by comparing the numbers or symbols marked on the cards located in the third round 200c.

In the case of FIG. 3D, the number of a card located in the third round 200c on the red side 120a of the card placement zone 120 is 1, the number of a card located in the third round 200c on the blue side 120b is also 1, and thus the red side 120a and the blue side 120b form a tie.

As the card comparison result of the third round 200c is a tie, all the players may progress to the next round of the game without award or forfeit. In this way, when the card comparison result is a tie, the dealer progresses to the next round of the game without determining the outcome.

In addition, since all the numbers of open cards on the blue side 110b of the card placement zone 120 are equally 1, the fifth player P5 who makes the option bet on the blue side 110b has not yet finished the game until the cards of all the rounds are turned over and viewed.

Thus, the second and fourth players P2 and P4 and the fifth player P5 progress to the next round of the game without change.

Next, the dealer turns over the cards located on the red side 120a and the blue side 120b located in the fourth round 200d of the card placement zone 120 so that the numbers or symbols are exposed to the outside. The dealer may determine the outcome between the red side 120a and the blue side 120b through a predetermined rank by comparing the numbers or symbols marked on the cards located in the fourth round 200d.

In the case of FIG. 3E, the number of a card located in the fourth round 200d on the red side 120a of the card placement zone 120 is 2, the number of a card located in the fourth round 200d on the blue side 120b is 1, and thus the red side 120a wins, and the blue side 120b loses.

As a result of the comparison between the cards of the fourth round 200d, as the red side 110a wins, the second player P2 who makes a bet on the red side 110a in the fourth round 300d of the betting zone 110 becomes a winner, and the fourth player P4 who makes a bet on the blue side 110b in the fourth round 300d of the betting zone 110 becomes a loser.

Thus, the dealer awards game chips to the winning second player P2 in accordance with the betting award rate of the fourth round on the basis of the betting amount and forfeits all game chips (all game chips bet in the betting zones 110a and 110b) of all rounds on which the losing fourth player P4 makes bets. That is, as the second player P2 wins in the fourth round, game chips bet by 10 times the betting award rate of the fourth round will be awarded.

Meanwhile, since all the numbers of open cards of all rounds on the blue side 110b of the card placement zone 120 are equally 1, game chips corresponding to the betting award rate for the option bet on the basis of the betting amount are awarded to the fifth player P5 who makes the option bet on the blue side 110b. That is, as the fifth player P5 wins in the option betting, game chips bet by 50 times the betting award rate for the option betting will be awarded.

Further, when cards of all rounds are completely visible, one game is finished, and a second game as described above may progress through card dealing by the dealer.

In this way, in the present disclosure, the outcome can be determined two or more times in a single process in which the dealer deals cards, the dealer does not need to shuffle and deal cards every time the game progresses to the next round, and thus a hassle of shuffling and dealing cards in every game can be reduced. Further, the player can play the game continuously, and thus can play many games in a short period of time.

As described above, the card game table and the game method using the same according to the present disclosure may have the following effects.

First, betting can be made in a win-loss method using numbers or patterns of cards and award rates for respective rounds can be differentially applied to progress a game.

Second, using simple game rules, players of all ages as well as players who play a game for the first time can easily participate in the game.

Third, an outcome can be determined two or more times through one progress in which a player selects a betting target to bet game chips and a dealer deals cards. Thus, the dealer can reduce a process of shuffling and dealing cards every time the game progresses to a next round, and the player can play games in succession. That is, the player can quickly bet many game chips in a short period of time, and the dealer can reduce the hassle of shuffling and dealing cards in every game.

In addition to the above-described effects, the detailed effects of the present disclosure have been be described when specific details for implementing the disclosure are described above.

All documents, including published documents, patent applications, patents, and the like, cited in the disclosed embodiments, may be incorporated into the disclosed embodiments in the same manner as if cited documents are individually and specifically combined and represented or as if the disclosed embodiments are combined and represented as a whole.

In order to understand the disclosed embodiments, reference signs have been described in exemplary embodiments illustrated in the accompanying drawings. In order to describe the disclosed embodiments, specific terms are used. However, the disclosed embodiments are not limited by the specific terms, and the disclosed embodiments may include all components commonly conceivable by those skilled in the art.

Specific implementations described in the disclosed embodiments are merely embodiments and are not intended to limit the scope of the disclosed embodiments in any manners. Further, when there is no specific mention such as “essential” or “important,” a component may not be essential for application of the disclosed embodiments.

Further, those skilled in the art in the technical field of the present disclosure will understand that various embodiments are possible within the scope of the technical spirit of the present disclosure. Thus, the technical protection scope of the present disclosure will be defined by the technical spirit of the appended claims.

1. A game pad that is provided on an upper surface of a game table at which a dealer and players are located, the game pad is configured for a betting zone and a card placement zone necessary for progress of a card game comprising a plurality of rounds from a first round to an N^{th} round, N being an integer greater than 1,
wherein the betting zone is a region in which a player places a game chip for betting when the card game progresses and is provided with a pair of sides comprising a first betting side and a second betting side, each betting side being configured as a layout having a plurality of regions to which a first round to an N^{th} round are sequentially designated, and each betting side being additionally configured with a layout having an option region at an uppermost end, and
wherein the card placement zone is a region in which the dealer places cards for progress of the card game when the card game progresses and is provided with a pair of sides comprising a first card placement side and a second card placement side, each card placement side being configured as a layout having a plurality of regions to which a first round to an N^{th} round are sequentially designated.

2. The game pad of claim 1, wherein the plurality of the regions of the betting zone are sequentially designated according to number of rounds, wherein award rates for each round increase as the number of rounds increases, and wherein an award rate of the option region is the highest.

3. (canceled)
